(19) United States
(12) Patent Application Publication
(10) Pub. No.: US 2021/0016525 A1
(43) Pub. Date: Jan. 21, 2021

(54) LOCALIZED REINFORCEMENT PANELS

(71) Applicant: The Boeing Company, Chicago, IL (US)

(72) Inventors: Michael J. Cloud, Snohomish, WA (US); Xiaoxi Wang, Mukilteo, WA (US); Jason Turner, Marysville, WA (US)

(21) Appl. No.: 16/513,687

(22) Filed: Jul. 16, 2019

(51) Int. Cl. B29C 70/88; B29C 70/08; B29C 51/12; B29C 70/22

(52) U.S. Cl. CPC B29C 70/887; B29C 70/085; B32B 5/12; B29C 70/228; B29C 51/12

(57) ABSTRACT

Disclosed herein is a reinforced panel. The reinforced panel is produced by a process that comprises applying a reinforcing fiber material, comprising a first polymeric material, to only a portion of a panel sheet, comprising a second polymeric material. The process also comprises, after applying the reinforcing fiber material to the panel sheet, thermoforming both the second polymeric material of the panel sheet and the first polymeric material of the reinforcing fiber material. The thermoforming integrally couples the panel sheet with the reinforcing fiber material to produce the reinforced panel by fusion bonding the first polymeric material with the second polymeric material. The reinforced panel includes one or more reinforced portions, defined by the reinforcing fiber material, and one or more non-reinforced portions, defined between the reinforcing fiber material.

### FIELD

This disclosure relates generally to localized reinforcement on panels, such as panels for aerospace applications, and more particularly to panels having reinforcing fiber material integrally coupled with a panel sheet at only a portion of the panel.

### BACKGROUND

Many aerospace structures, such as airplanes and rockets, are constructed using panels to create external surfaces and internal surfaces of the structures. Conventionally, panels are made with thermoset resin materials. However, thermoplastics may also be used for manufacturing panels. Using thermoplastics may be advantageous because they can be more easily used in a thermoforming process to produce complex contoured panels with relatively high surface quality (e.g., smoothness). Thermoplastic panels are generally made from stock (i.e., “modular” or “standard”) sheets. The sheets are thermoformed into a panel, having a desired shape, for use in constructing an aerospace structure.

Some panels need to have a relatively high strength because they provide load bearing within an aerospace structure, while others merely provide aesthetics, protection from contamination, or other non-load-bearing functions. However, because thermoplastic panels are generally made from standard or modular sheets, options can be limited for providing relatively high strength to some, but not all, of the panels. For example, a panel can be configured for load bearing by adding additional layers of the modular sheets or other material to reinforce the entire panel. Additionally, some panels may require relatively high strength in only a portion of the respective panels. In these situations, reinforcing the entire panel adds unnecessary weight and cost.

### SUMMARY

The subject matter of the present application provides various examples of reinforced panels and techniques for producing reinforced panels that overcome the above-discussed shortcomings of prior art techniques. The subject matter of the present application has been developed in response to the present state of the art, and in particular, in response to shortcomings of conventional reinforced panels, and the conventional methods and systems for producing reinforced panels, particularly those that are reinforced in only a portion of the panel.

Disclosed herein is a reinforced panel produced by a process that comprises applying a reinforcing fiber material, comprising a first polymeric material, to only a portion of a panel sheet, comprising a second polymeric material. The process also comprises, after applying the reinforcing fiber material to the panel sheet, thermoforming both the second polymeric material of the panel sheet and the first polymeric material of the reinforcing fiber material. Thermoforming integrally couples the panel sheet with the reinforcing fiber material to produce the reinforced panel by fusion bonding the first polymeric material with the second polymeric material. The reinforced panel includes one or more reinforced portions, defined by the reinforcing fiber material, and one or more non-reinforced portions, defined between the reinforcing fiber material. The preceding subject matter of this paragraph characterizes example 1 of the present disclosure.

Applying the reinforcing fiber material comprises adhering the reinforcing fiber material to a predetermined load path of the reinforced panel. The preceding subject matter of this paragraph characterizes example 2 of the present disclosure, wherein example 2 also includes the subject matter according to example 1, above.

The predetermined load path is predetermined based on a simulated loading of the reinforced panel for a planned use of the reinforced panel. The preceding subject matter of this paragraph characterizes example 3 of the present disclosure, wherein example 3 also includes the subject matter according to example 2, above.

Applying the reinforcing fiber material comprises adhering the reinforcing fiber material to the panel sheet with a bonding material. The preceding subject matter of this paragraph characterizes example 4 of the present disclosure, wherein example 4 also includes the subject matter according to any one of examples 1-3, above.

The second polymeric material of the panel sheet is the same as the first polymeric material of the reinforcing fiber material. The preceding subject matter of this paragraph characterizes example 5 of the present disclosure, wherein example 5 also includes the subject matter according to any one of examples 1-4, above.

The first polymeric material is a first uncured thermoset material and the second polymeric material is a second uncured thermoset material or a thermoplastic material. The preceding subject matter of this paragraph characterizes example 6 of the present disclosure, wherein example 6 also includes the subject matter according to any one of examples 1-5, above.

The first polymeric material is a first thermoplastic material and the second polymeric material is a second thermoplastic material or a thermoset material. The preceding subject matter of this paragraph characterizes example 7 of the present disclosure, wherein example 7 also includes the subject matter according to any one of examples 1-5, above.

The process further comprises selecting the panel sheet for reinforcement from a set of substantially identical panel sheets. Each one of the panel sheets of the set of substantially identical panel sheets is devoid of a reinforcing fiber material applied to only a portion of the panel sheet. The preceding subject matter of this paragraph characterizes example 8 of the present disclosure, wherein example 8 also includes the subject matter according to any one of examples 1-7, above.

The reinforcing fiber material comprises one or more of carbon fiber, fiber glass, and thermoplastic fiber. The preceding subject matter of this paragraph characterizes example 9 of the present disclosure, wherein example 9 also includes the subject matter according to any one of examples 1-8, above.

The one or more reinforced portions of the panel sheet comprise one or more of (1) an area of the panel sheet configured to be adjacent to a hinge; (2) an area of the panel sheet configured to be adjacent to a latch; (3) an area of the panel sheet defining an outside edge of the panel sheet; (4) an area of the panel sheet (104) configured to receive a fastener; and (5) an area of the panel sheet configured for coupling the panel sheet to another panel sheet or another part. The preceding subject matter of this paragraph characterizes example 10 of the present disclosure, wherein example 10 also includes the subject matter according to any one of examples 1-9, above.

Further disclosed herein is a method of reinforcing a panel. The method comprises applying reinforcing fiber material, comprising a first polymeric material, to only a portion of a panel sheet, comprising a second polymeric material. The method also comprises, after applying the reinforcing fiber material to the panel sheet, thermoforming both the second polymeric material of the panel sheet and the first polymeric material of the reinforcing fiber material. Thermoforming integrally couples the panel sheet with the reinforcing fiber material to produce a reinforced panel, by fusion bonding the first polymeric material with the second polymeric material. The reinforced panel includes one or more reinforced portions, defined by the reinforcing fiber material, and one or more non-reinforced portions defined between the reinforcing fiber material. The preceding subject matter of this paragraph characterizes example 11 of the present disclosure.

Applying the reinforcing fiber material comprises adhering the reinforcing fiber material to a predetermined load path of the reinforced panel. The preceding subject matter of this paragraph characterizes example 12 of the present disclosure, wherein example 12 also includes the subject matter according to example 11, above.

The method further comprises selecting the panel sheet for reinforcement from a set of substantially identical panel sheets. Each one of the panel sheets of the set of substantially identical panel sheets is devoid of a reinforcing fiber material applied to only a portion of the panel sheet. The preceding subject matter of this paragraph characterizes example 13 of the present disclosure, wherein example 13 also includes the subject matter according to any of examples 11 and 12, above.

Additionally disclosed herein is a reinforced panel. The panel comprises a substrate material having a non-zero thickness over a length and width of the reinforced panel. The panel also comprises one or more reinforced portions are defined by reinforcing fiber material integrally coupled to the substrate material. The reinforcing fiber material is integrally coupled to the substrate material via thermoforming. The panel further comprises one or more non-reinforced portions that are devoid of the reinforcing fiber material. The preceding subject matter of this paragraph characterizes example 14 of the present disclosure.

The one or more reinforced portions include a predetermined load path of the reinforced panel. The preceding subject matter of this paragraph characterizes example 15 of the present disclosure, wherein example 15 also includes the subject matter according to example 14, above.

A total area of the one or more reinforced portions is less than a total area of the one or more non-reinforced portions. The preceding subject matter of this paragraph characterizes example 16 of the present disclosure, wherein example 16 also includes the subject matter according to any of examples 14 and 15, above.

A thickness of one of the reinforced portions is greater than a thickness of an adjacent one of the non-reinforced portions. The preceding subject matter of this paragraph characterizes example 17 of the present disclosure, wherein example 17 also includes the subject matter according to any of examples 14-16, above.

The substrate material comprises a composite of two or more constituent materials. The preceding subject matter of this paragraph characterizes example 18 of the present disclosure, wherein example 18 also includes the subject matter according to any one of examples 14-17, above.

The reinforcing fiber material comprises one or more of carbon fiber, fiber glass, and thermoplastic fiber. The preceding subject matter of this paragraph characterizes example 19 of the present disclosure, wherein example 19 also includes the subject matter according to any one of examples 14-18, above.

The one or more reinforced portions of the reinforced panel comprise one or more of: (1) an area of the panel sheet configured to be adjacent to a hinge; (2) an area of the panel sheet configured to be adjacent to a latch; (3) an area of the panel sheet defining an outside edge of the panel sheet; (4) an area of the panel sheet configured to receive a fastener; and (5) an area of the panel sheet configured for coupling the panel sheet to another panel sheet or another part. The preceding subject matter of this paragraph characterizes example 20 of the present disclosure, wherein example 20 also includes the subject matter according to any one of examples 14-19, above.

The described features, structures, advantages, and/or characteristics of the subject matter of the present disclosure may be combined in any suitable manner in one or more examples, including embodiments and/or implementations. In the following description, numerous specific details are provided to impart a thorough understanding of examples of the subject matter of the present disclosure. One skilled in the relevant art will recognize that the subject matter of the present disclosure may be practiced without one or more of the specific features, details, components, materials, and/or methods of a particular example, embodiment, or implementation. In other instances, additional features and advantages may be recognized in certain examples, embodiments, and/or implementations that may not be present in all examples, embodiments, or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific examples that are illustrated in the appended drawings. Understanding that these drawings depict only typical examples of the subject matter, they are not therefore to be considered to be limiting of its scope. The subject matter will be described and explained with additional specificity and detail through the use of the drawings, in which:

FIG. 1 shows a process for producing a reinforced panel according to one or more examples of the present disclosure;

FIG. 2a is a side view of the reinforced panel of FIG. 1, showing a thermoforming or curing process, according to one or more examples of the present disclosure;

FIG. 2b is a side view of the reinforced panel of FIG. 1, showing a thermoforming or curing process, according to one or more examples of the present disclosure;

FIG. 3 is a top view of a reinforced panel, according to one or more examples of the present disclosure; and

FIG. 4 is a schematic flow diagram of a method of making a reinforced panel, according to one or more examples of the present disclosure.

### DETAILED DESCRIPTION

Reference throughout this specification to “one example,” “an example,” or similar language means that a particular feature, structure, or characteristic described in connection with the example is included in at least one example of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more examples of the present disclosure, however, absent an express correlation to indicate otherwise, an implementation may be associated with one or more examples.

Disclosed herein are reinforced panels that are locally reinforced and techniques for producing the reinforced panels. The reinforced panels include one or more reinforced portions defined by reinforcing fiber material integrally coupled to a substrate material at the one or more reinforced portions. The reinforced panels also include one or more non-reinforced portions defined between the reinforcing fiber material. The reinforced panels can be produced by a process including applying (e.g., with a temporary coupling) reinforcing fiber material, comprising a first polymeric material, to only a portion of a panel sheet that comprises a second polymeric material. The process then includes thermoforming the first polymeric material and the second polymeric material. In the thermoforming process, the first polymeric material fusion bonds with the second polymeric material to integrally couple the panel sheet with the reinforcing fiber material at the reinforced portions.

Accordingly, the reinforced panels can be reinforced in some portions and not in others. This can reduce one or more of cost, weight, and manufacturing complexity for a reinforced panel when compared with a panel that has been reinforced using conventional techniques.

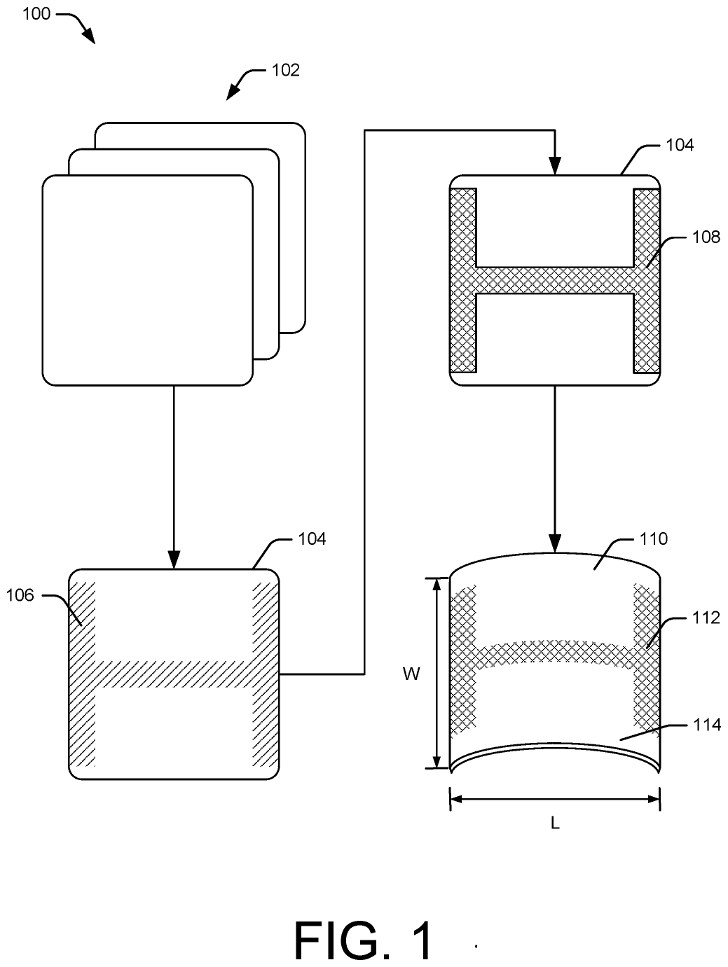

Referring to FIG. 1, according to some examples, disclosed herein is a process 100 for producing a reinforced panel 110. The process 100 may include selecting a panel sheet 104 from a set 102 of substantially identical panel sheets 104 (“stock sheets”).

In some embodiments, each member of the set 102 of substantially identical panel sheets comprises and/or consists of a same material or configuration of materials. For example, each panel sheet 104 may comprise one or more of thermoplastic materials, thermoset material, metal materials, or a composite of multiple materials. The material may be configured with uniformity across one or more of a length, width, and thickness. Alternatively, the material may be layered and/or may be arranged with a honeycomb core. Further, each one of the panel sheets in the set 102 of substantially identical panel sheets may be devoid of a reinforcing fiber material applied to only a portion of the respective panel sheets.

Each member of the set 102 of substantially identical panel sheets may be configured with a common width, common length, and/or common thickness. Additionally, one or more member of the set 102 of substantially identical panel sheets, including the panel sheet 104, may include a polymeric material. The polymeric material of the panel sheet 104 may be, for example, an uncured thermoset material or thermoplastic material. In some implementations, the panel sheet 104 may consist of the polymeric material, such as nylon, or may have the polymeric material generally uniformly disposed through the panel sheet 104. Alternatively, the polymeric material may be disposed on a surface of the panel sheet 104.

The process 100 may also include determining a load path 106 of the reinforced panel 110. The predetermined load path 106 may be predetermined based on a simulated loading of the reinforced panel 110 for a planned use of the reinforced panel 110. In some implementations, the load path 106 is determined as an area of the reinforced panel that is expected to be under stress based on its function, e.g., as an area for coupling to, or supporting, another panel or another part.

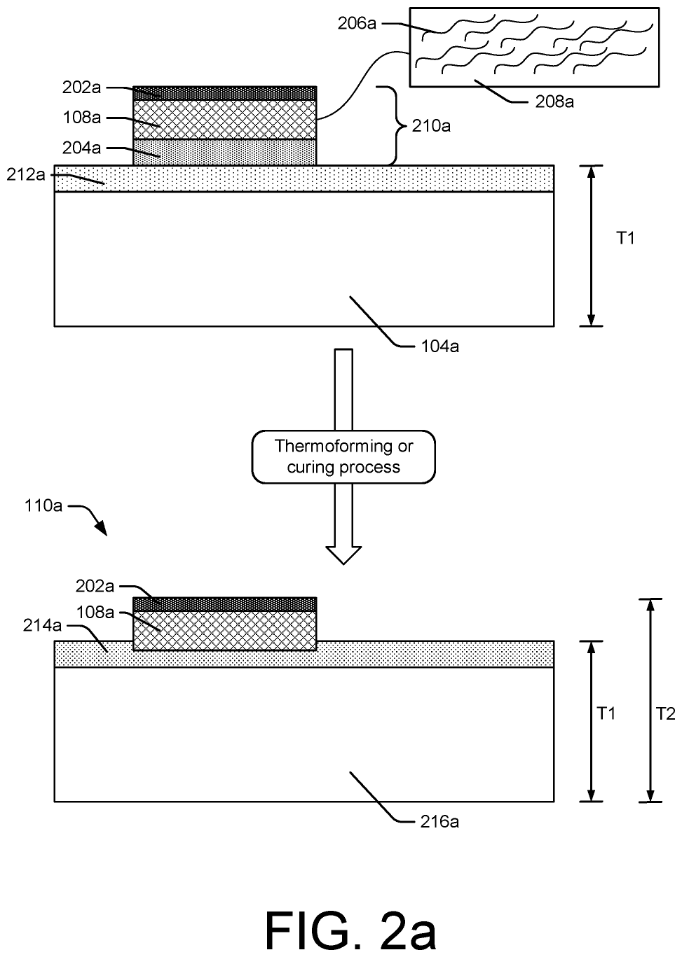

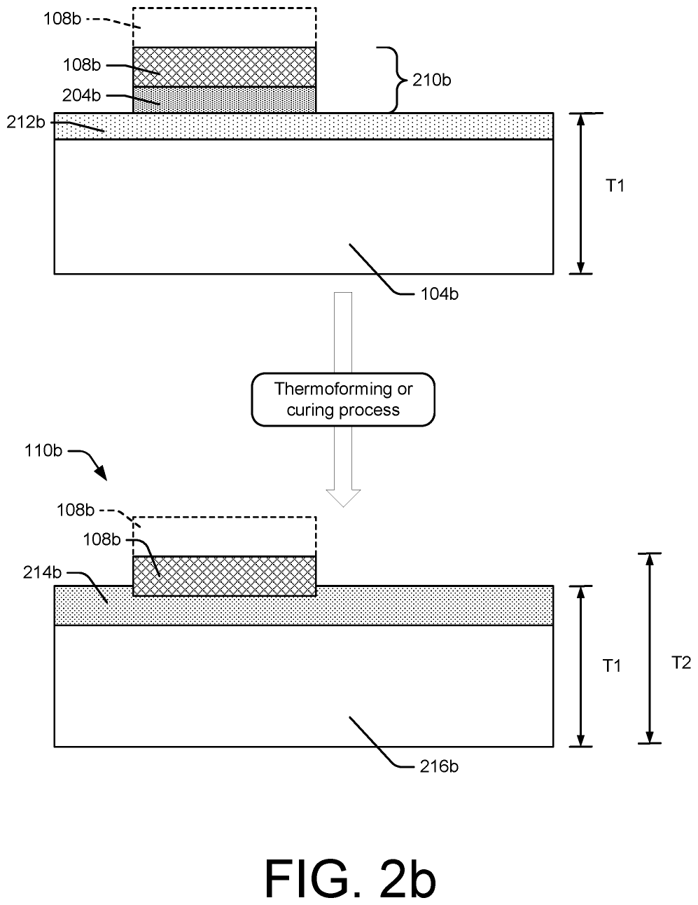

The process 100 may include applying a reinforcing fiber material 108 to only a portion of the panel sheet 104. For example, the reinforcing fiber material 108 may be applied to less than 80%, less than 50%, less than 30%, or less than 20% of the panel sheet 104. Applying the reinforcing fiber material 108 may include adhering the reinforcing fiber material 108 to the panel sheet 104 along the predetermined load path 106. In some implementations, applying the reinforcing fiber material 108 may include adhering multiple layers of the reinforcing fiber material 108 to the panel sheet 104 at one or more locations. For example, as shown in FIG. 2b, at least one additional layer of reinforcing fiber material 108b is optionally stacked on another layer of reinforcing fiber material 108b to create multiple layers of reinforcement. Additionally, different locations of the panel sheet 104 may have different quantities of layers of the reinforcing fiber material 108.

Applying the reinforcing fiber material 108 may include adhering the reinforcing fiber material 108 to the panel sheet 104 with a bonding material. The bonding material may be comprised within a fibrous tape or fabric, or may be applied separately from the reinforcing fiber material 108 as a paste or liquid, for example. The bonding material may include one or more of a resin, epoxy, pressure-sensitive adhesive, foam or other tape, ultraviolet adhesive, fusion bonding material, tacky thermoset resin, and another adhesive. In some implementations, the bonding material includes a resin that comprises one or more of a thermoplastic material or a thermoset material.

The reinforcing fiber material 108 may include, for example, one or more of carbon fiber, fiber glass, and thermoplastic fiber (e.g., polypropylene, polyethylene, polyetherimide, etc.). The reinforcing fiber material 108 may also include a polymeric material selected and/or configured to be fusion bonded with the polymeric material of the panel sheet 104. The polymeric material of the reinforcing fiber material 108 may be, for example, an uncured thermoset material or a thermoplastic material. In some implementations, the polymeric material is pre-impregnated within the reinforcing fiber material 108.

In some implementations, the polymeric material of the reinforcing fiber material 108 and the polymeric material of the panel sheet 104 comprise, or consist of, a same polymeric material. In such implementations, the panel sheet 104 and the reinforcing fiber material 108 can more easily be recycled. In a particular embodiment, the polymeric material comprises a nylon resin, which may be pre-impregnated into a fibrous sheet, tape, or ply having the reinforcing fiber material 108, and the panel sheet 104 comprises nylon at least at a portion of the surface to which the reinforcing fiber material 108 is applied. In another particular implementation, dry polyethylene fiber is used adhered to a polyethylene panel sheet 104.

Referring again to FIG. 1, after applying the reinforcing fiber material 108 to the panel sheet, the process includes thermoforming both the polymeric material of the panel sheet 104 and the polymeric material of the reinforcing fiber material 108. The thermoforming integrally couples the panel sheet 104 with the reinforcing fiber material 108 to produce the reinforced panel 110 by fusion bonding the first polymeric material with the second polymeric material.

The reinforced panel 110 includes one or more reinforced portions 112, defined by the reinforcing fiber material 108, and one or more non-reinforced portions 114, defined between the reinforcing fiber material 108. In other words, the reinforced portions 112 are defined as having the reinforcing fiber material 108 fusion bonded to a surface of the reinforced portion 112, whereas the non-reinforced portions 114 may be devoid of reinforcing fiber material 108 fusion bonded thereto. A total area of the one or more reinforced portions 112 may be less than a total area of the one or more non-enforced portions 114. In particular, the total area of the one or more reinforced portions 112 make up less than 80%, less than 50%, less than 30%, or less than 20% of the reinforced panel 110.

In some embodiments, the panel sheet 104 comprises fiber material, and the reinforced portions 112 are defined as portions of the panel sheet 104 having reinforcing (e.g., additional) fiber material 108 fusion bonded thereto.

Initially, the panel sheet 104, with the reinforcing fiber material 108 thereon, has a planar, 2-dimensional, shape. However, the reinforced panel 110 may be thermoformed into a nonplanar shape, such as a shape having complex contours and/or cut outs. For example, as shown in FIG. 1, the planar, 2-dimensional, panel sheet 104, with the reinforcing fiber material 108, has been formed into a reinforced panel 110 with a non-planar, 3-dimensional, shape. Accordingly, the reinforcing fiber material 108, along with the panel sheet 104, can be reshaped from a 2-dimensional shape into a 3-dimensional shape. Although the reinforced panel 110 of FIG. 1 has one particular 3-dimensional shape, in other examples, the reinforced panel 110 can have any of various 3-dimensional shapes. The reinforced panel 110 may be defined with a length (L) and a width (W), although the length (L) and the width (W) may not necessarily be constant along an entirety of the reinforced panel 110 as they are in FIG. 1.

The thermoforming process mentioned above may include integrally coupling the reinforcing fiber material 108 to the panel sheet 104 via a heating process (e.g., curing, melting, or semi-melting process).

Referring to FIG. 2a, the panel sheet 104a comprises a polymeric material 212a disposed on, adjacent to, or proximate to, a surface of the panel sheet 104a upon which the reinforcing fiber material 108a is applied. As described above, the entire panel sheet 104a may consist of the polymeric material 212a or may have the polymeric material 212a generally uniformly disposed through the panel sheet 104a.

The reinforcing fiber material 108a may be comprised in a delivery mechanism 210a, such as a fibrous tape or fabric. The delivery mechanism comprises one or more of the reinforcing fiber material 108a, a backing 202a, and a bonding material 204a. The bonding material 204a provides a temporary adhesion between the reinforcing fiber material 108a and the panel sheet 104a. The backing 202a may be used to prevent exposure of the reinforcing fiber material 108a after a thermoforming or curing process is performed. The backing 202a may include thermoset or thermoplastic material, which in some implementations, is devoid of a same fibrous material as the reinforcing fiber material 108a. Alternatively, the backing 202a may include another material configured for coupling the reinforced panel 110a to another panel or another part.

The reinforcing fiber material 108a may comprise fibers 206a and polymeric material 208a. In this way, the polymeric material 208a may be described as impregnating the reinforcing fiber material 108a. Additionally, the polymeric material 208a may comprise the bonding material 204a that adheres the reinforcing fiber material 108a to the panel sheet 104a.

During a thermoforming or curing process, the polymeric material 208a of the reinforcing fiber material 108a and the polymeric material 212a of the panel sheet 104a are fusion bonded together in a fusion bonding region 214a of a substrate material 216a of the reinforced panel 110a. The thermoforming or curing process may also include shaping the panel sheet 104a into a desired shape of the reinforced panel 110a. After the thermoforming or curing process, the reinforcing fiber material 108 is integrally coupled to the substrate material 216. The reinforcing fiber material 108a may extend into the fusion bonding region 214a during and after the thermoforming or curing process.

The panel sheet 104a is defined with a thickness T1 before thermoforming. After thermoforming or curing, the reinforced panel 110a is defined as having a thickness T1 at non-reinforced portions 114 and a thickness T2 at reinforced portions 112. The thickness T2 of the reinforced portions 112 may be greater than a thickness of an adjacent one of the one or more non-reinforced portions 114. The thickness T2 of a reinforced portion 112, defined by the reinforcing fiber material 108a fusion bonded to a surface of a substrate material 216a of the reinforced panel 110a, may be less than a sum of the thickness T1 of the substrate material 216a and a thickness of the delivery mechanism 210a.

Referring to FIG. 2b, the delivery mechanism 210b comprises the reinforcing fiber material 108b and the bonding material 204b without the backing 202a of FIG. 2a. In the example of FIG. 2b, the reinforcing fiber material 108b is temporarily adhered, using a bonding material 204b, to the panel sheet 104b at a surface including a polymeric material 212b. During the thermoforming or curing process, the reinforcing fiber material 108b integrally couples with the substrate material 216b via the polymeric material 212b.

The delivery mechanism 210b includes a polymeric material, which can be disposed within the reinforcing fiber material 204b, as illustrated in FIG. 2a. Alternatively, the polymeric material may be disposed in, or may consist of, the bonding material 204b. For example, the reinforcing fiber material 204b may be a dry fiber material. The bonding material 204b may be a paste or liquid that comprises a tacky polymeric material. The bonding material 204b is applied to the panel sheet 104b and the dry fiber material is disposed upon the bonding material 204 to temporarily bond the dry fiber material to the panel sheet 104. When the thermoforming or curing process is performed, the bonding material 204b, which includes the polymeric material, fusion bonds the dry fiber material with the polymeric material 212b within a fusion bonding region 214b.

The reinforced panel 110b is defined as having a thickness T1 at non-reinforced portions 114 and a thickness T2 at reinforced portions 112. A thickness T2 of a reinforced portion, defined by the reinforcing fiber material 108b fusion bonded to a surface of a substrate material 216b of the reinforced panel 110b, may be less than a sum of the thickness T1 of the substrate material 216b and a thickness of the delivery mechanism 210b.

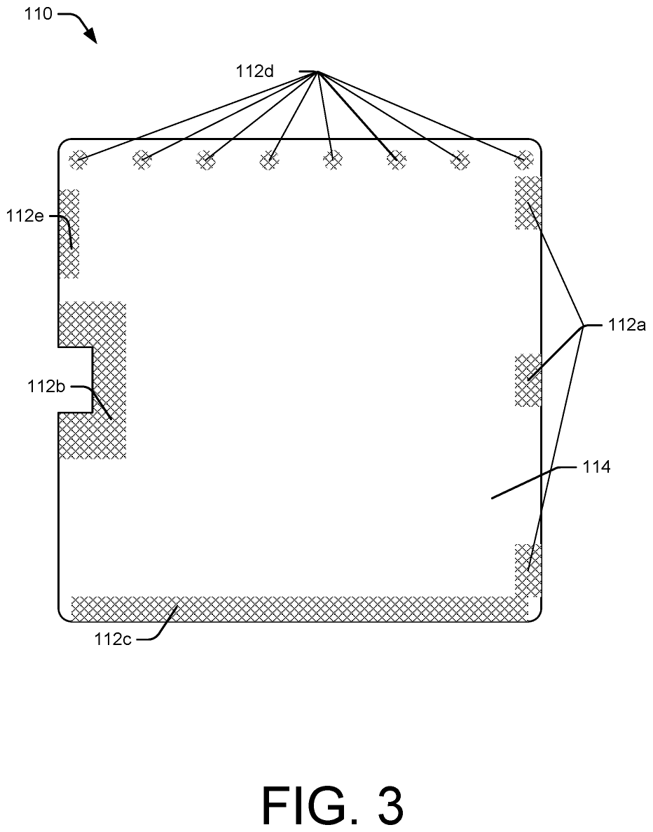

Referring to FIG. 3, a reinforced panel 110 may have one or more reinforced portions 112. As shown, reinforced portions may include one or more of an area 102a of the panel sheet 104 configured to be adjacent to a hinge; an area 112b of the panel sheet 104 configured to be adjacent to a latch; an area 112c of the panel sheet 104 defining an outside edge of the panel sheet 104; an area 112d of the panel sheet 104 configured to receive a fastener; and an area 112e of the panel sheet 104 configured for coupling the panel sheet 104 to another panel sheet 104 (e.g., after thermoforming or curing the other panel sheet 104) or another part.

One or more non-reinforced portions 114 of the reinforced panel 110 are defined between reinforcing fiber material 108. In some implementations, the reinforced panel 110 consists of one or more reinforced portions 112 and one or more non-reinforced portions 114.

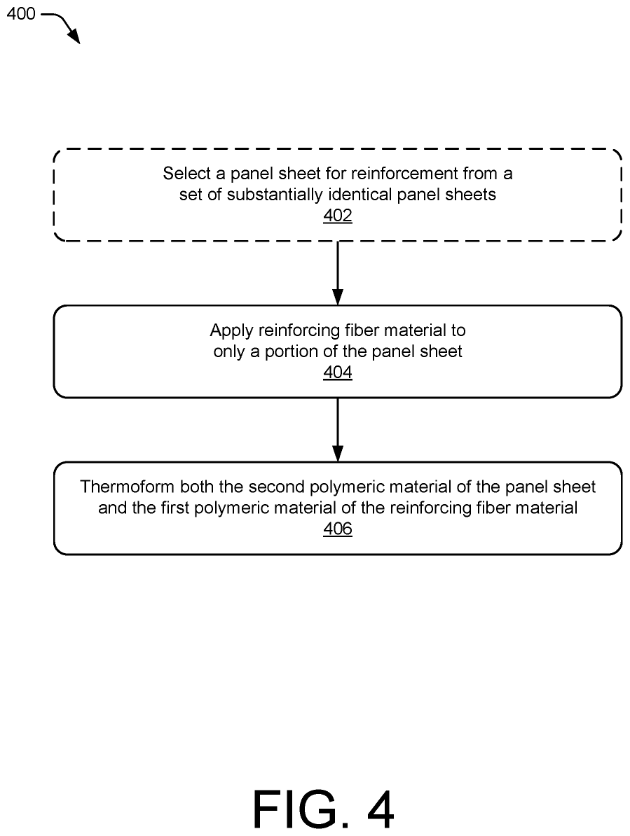

Now referring to FIG. 4, according to certain examples, a method 400 of reinforcing a panel is shown. The method 400 is performed in producing any one or more of the examples of the reinforced panel 110 disclosed herein. The method 400 optionally includes (block 402) selecting a panel sheet 104 for reinforcement from a set 102 of substantially identical panel sheets 104. The method 400 also includes (block 404) applying reinforcing fiber material 108, comprising a first polymeric material, to only a portion of a panel sheet 104, comprising a second polymeric material. After applying the reinforcing fiber material 108 to the panel sheet 104 at block 404, the method 400 additionally includes (block 406) thermoforming both the second polymeric material of the panel sheet 104 and the first polymeric material of the reinforcing fiber material 108.

Thermoforming, at block 406, integrally couples the panel sheet 104 with the reinforcing fiber material 108 to produce a reinforced panel 110, by fusion bonding the first polymeric material 208 with the second polymeric material 212. Additionally or alternatively, the reinforced panel 110 includes one or more reinforced portions 112, defined by the reinforcing fiber material 108, and one or more non-reinforced portions 114 defined between the reinforcing fiber material 108.

In certain examples of the method 400, applying the reinforcing fiber material 108 at block 404 comprises adhering the reinforcing fiber material 108 to a predetermined load path 106 of the reinforced panel 110. For example, the load path may be predetermined based on a simulated loading of the reinforced panel 110 for a planned use of the reinforced panel 110. In some examples of the method 400, each one of the panel sheets (104) of the set (102) of substantially identical panel sheets is devoid of a reinforcing fiber material (108) applied to only a portion of the panel sheet (104).

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.”

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The schematic flow chart diagrams included herein are generally set forth as logical flow chart diagrams. As such, the depicted order and labeled steps are indicative of one example of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present subject matter may be embodied in other specific forms without departing from its spirit or essential characteristics. The described examples are to be considered in all respects only as illustrative and not restrictive. All changes which come within the meaning and range of equivalency of the claims are to be embraced within their scope.

What is claimed is:

1. A reinforced panel produced by a process comprising:
applying a reinforcing fiber material, comprising a first polymeric material, to only a portion of a panel sheet, comprising a second polymeric material; and
after applying the reinforcing fiber material to the panel sheet, thermoforming both the second polymeric material of the panel sheet and the first polymeric material of the reinforcing fiber material;
wherein:
thermoforming integrally couples the panel sheet with the reinforcing fiber material to produce the reinforced panel by fusion bonding the first polymeric material with the second polymeric material; and
the reinforced panel includes one or more reinforced portions, defined by the reinforcing fiber material, and one or more non-reinforced portions, defined between the reinforcing fiber material.

2. The reinforced panel according to claim 1, wherein applying the reinforcing fiber material comprises adhering the reinforcing fiber material to a predetermined load path of the reinforced panel.

3. The reinforced panel according to claim 2, wherein the predetermined load path is predetermined based on a simulated loading of the reinforced panel for a planned use of the reinforced panel.

4. The reinforced panel according to claim 1, wherein applying the reinforcing fiber material comprises adhering the reinforcing fiber material to the panel sheet with a bonding material.

5. The reinforced panel according to claim 1, wherein the second polymeric material of the panel sheet is the same as the first polymeric material of the reinforcing fiber material.

6. The reinforced panel according to claim 1, wherein the first polymeric material is a first uncured thermoset material and the second polymeric material is a second uncured thermoset material or a thermoplastic material.

7. The reinforced panel according to claim 1, wherein the first polymeric material is a first thermoplastic material and the second polymeric material is a second thermoplastic material or a thermoset material.

8. The reinforced panel according to claim 1, wherein the process further comprises selecting the panel sheet for reinforcement from a set of panel sheets, wherein the panel sheets of the set of panel sheets are substantially identical and each one of the panel sheets of the set of panel sheets is devoid of a reinforcing fiber material applied to only a portion of the panel sheet.

9. The reinforced panel according to claim 1, wherein the reinforcing fiber material comprises one or more of carbon fiber, fiber glass, and thermoplastic fiber.

10. The reinforced panel according to claim 1, wherein the one or more reinforced portions of the panel sheet comprise one or more of:
an area of the panel sheet configured to be adjacent to a hinge;
an area of the panel sheet configured to be adjacent to a latch;
an area of the panel sheet defining an outside edge of the panel sheet;
an area of the panel sheet configured to receive a fastener; and
an area of the panel sheet configured for coupling the reinforced panel to another panel sheet or another part.

11. A method of reinforcing a panel, the method comprising:
applying a reinforcing fiber material, comprising a first polymeric material, to only a portion of a panel sheet, comprising a second polymeric material; and
after applying the reinforcing fiber material to the panel sheet, thermoforming both the second polymeric material of the panel sheet and the first polymeric material of the reinforcing fiber material;
wherein:
thermoforming integrally couples the panel sheet with the reinforcing fiber material to produce a reinforced panel, by fusion bonding the first polymeric material with the second polymeric material; and
the reinforced panel includes one or more reinforced portions, defined by the reinforcing fiber material, and one or more non-reinforced portions defined between the reinforcing fiber material.

12. The method according to claim 11, wherein applying the reinforcing fiber material comprises adhering the reinforcing fiber material to a predetermined load path of the reinforced panel.

13. The method according to claim 11, further comprising selecting the panel sheet for reinforcement from a set of panel sheets, wherein the panel sheets of the set of panel sheets are substantially identical and each one of the panel sheets of the set of panel sheets is devoid of a reinforcing fiber material applied to only a portion of the panel sheet.

14. A reinforced panel comprising:
a substrate material having a non-zero thickness over a length and width of the reinforced panel;
one or more reinforced portions defined by a reinforcing fiber material integrally coupled to the substrate material, the reinforcing fiber material integrally coupled to the substrate material via thermoforming; and
one or more non-reinforced portions that are devoid of the reinforcing fiber material.

15. The reinforced panel according to claim 14, wherein the one or more reinforced portions include a predetermined load path of the reinforced panel.

16. The reinforced panel according to claim 14, wherein a total area of the one or more reinforced portions is less than a total area of the one or more non-reinforced portions.

17. The reinforced panel according to claim 14, wherein a thickness of one of the reinforced portions is greater than a thickness of an adjacent one of the one or more non-reinforced portions.

18. The reinforced panel according to claim 14, wherein the substrate material comprises a composite of two or more constituent materials.

19. The reinforced panel according to claim 14, wherein the reinforcing fiber material comprises one or more of carbon fiber, fiber glass, and thermoplastic fiber.

20. The reinforced panel according to claim 14, wherein the one or more reinforced portions of the reinforced panel comprise one or more of:
an area of the panel sheet configured to be adjacent to a hinge;
an area of the panel sheet configured to be adjacent to a latch;
an area of the panel sheet defining an outside edge of the panel sheet;
an area of the panel sheet configured to receive a fastener; and
an area of the panel sheet configured for coupling the panel sheet to another panel sheet or another part.
